(19) United States
(12) Patent Application Publication
(10) Pub. No.: US 2011/0149332 A1
(43) Pub. Date: Jun. 23, 2011

(54) METHOD OF SETTING DISPLAY MODE IN IMAGE FORMING APPARATUS AND IMAGE FORMING SYSTEM TO SET THE DISPLAY MODE

(75) Inventor: Tae-gyun CHO, Hwaseong-si (KR)

(73) Assignee: Samsung Electronics Co., Ltd, Suwon-si (KR)

(21) Appl. No.: 12/974,246

(22) Filed: Dec. 21, 2010

(30) Foreign Application Priority Data
Dec. 21, 2009 (KR) 2009-128339

(51) Int. Cl. G06K 15/00; G06F 17/00

(52) U.S. Cl. 358/1.14; 715/273

(57) ABSTRACT

A method of setting a display mode in an image forming apparatus connected to an external apparatus via a network includes logging in to the image forming apparatus, authenticating log-in information according to the logging in at the image forming apparatus, displaying a document box and file stored in the image forming apparatus on a display unit according to the set display mode in accordance with a user corresponding to the authenticated log-in information, and selecting one of the displayed document box and file.

### CROSS-REFERENCE TO RELATED APPLICATIONS

This application claims the benefit of priority under 35 U.S.C. §119 to Korean Patent Application No. 10-2009-0128339, filed on Dec. 21, 2009, in the Korean Intellectual Property Office, the disclosure of which is incorporated herein in its entirety by reference.

### BACKGROUND

1. Field of the Invention

The present general inventive concept relates to a method of setting a display mode in an image forming apparatus and an image forming system for performing thereof.

2. Description of the Related Art

An image forming apparatus including a printer, a scanner, and a multi-function peripheral may use a document box or a predetermined location in memory to perform at least one of printing, copying, scanning, fax transmitting, e-mail sending, and server transferring functions. A user may store data (generated during printing, copying, scanning, fax transmitting, e-mail sending, and server transferring operations) using the document box. Storing data in document boxes in the image forming apparatus may allow a large amount of data corresponding to a plurality of users to be easily and conveniently managed.

### SUMMARY

The present general inventive concept provides a method of setting a display mode in an image forming apparatus to conveniently manage files and document boxes stored in the image forming apparatus and an image forming system to set the display mode.

Additional aspects and utilities of the present general inventive concept will be set forth in part in the description which follows and, in part, will be obvious from the description, or may be learned by practice of the present general inventive concept.

Features and/or utilities of the present general inventive concept may be realized by a method of setting a display mode of a document box and file, wherein the method is performed in an image forming apparatus including at least one document box, a file stored in the at least one document box, and a display unit and connected to an external apparatus via a network. The method may include setting a mode to display the document box and file on the display unit according to the display mode corresponding to a user of the image forming apparatus, logging in to the image forming apparatus, authenticating log-in information according to the logging in at the image forming apparatus, displaying the document box and file stored in the image forming apparatus on the display unit according to the set display mode in accordance with a user corresponding to the authenticated log-in information, and selecting one of the displayed document box and file, wherein the display mode includes a default mode and a history mode based on a usage history of the document box and file of the user.

Features and/or utilities of the present general inventive concept may also be realized by an image forming apparatus connected to an external apparatus via a network including a storing unit to store at least one document box and a file stored in the at least one document box, a setting unit to set a mode to display the stored document box and file according to a display mode corresponding to a user of the image forming apparatus an authenticating unit to authenticate log-in information obtained from one of a plurality of users of the image forming apparatus, a display unit to display the document box and file stored in the storing unit according to the set display mode in accordance with a user corresponding to the authenticated log-in information, an input unit to obtain input information about selecting one of the displayed document box and file, and a control unit to control the display of the document box and file stored in the storing unit according to the set display mode, wherein the display mode includes a default mode and a history mode based on a usage history of the document box and file of the user.

Features and/or utilities of the present general inventive concept may also be realized by an image forming system including an image forming apparatus and a host apparatus connected to the image forming apparatus via a network, including the image forming apparatus setting a display mode to display a document box and a file stored in the image forming apparatus corresponding to log-in information of the host apparatus, obtaining the log-in information from the host apparatus, authenticating the obtained log-in information, and transmitting information about a document box and a file to the host apparatus to display the document box and file on the host apparatus according to the set display mode, and the host apparatus receiving the information about a document box and a file from the image forming apparatus and displaying a document box and a file corresponding to the received information.

Features and/or utilities of the present general inventive concept may also be realized by a method of displaying files stored in an image forming apparatus, the method including detecting a set display mode among at least a default mode and a history mode to display files stored in at least one document box of the image forming apparatus, the default mode displaying the files regardless of access history of a user accessing the files and the history mode displaying the files based on the access history, and when the history mode is detected, displaying the at least one document box and files corresponding to predetermined history parameters.

The at least one document box may include a public document box to allow access to any user of the image forming apparatus, a secure document box to allow access to only authorized users of the image forming apparatus, and a user document box to allow access to only a user that is presently logged in to the image forming apparatus.

The method may further include receiving a user authentication and detecting the set display mode based on predetermined settings set by the authenticated user.

Detecting a set display mode may include receiving an input from a user interface of the image forming apparatus to set the display mode.

The method may further include displaying the at least one document box and files according to the detected set mode of the default mode and the history mode, upon displaying the at least one document box and files according to the detected set mode of the default mode and the history mode, receiving a user input to change the set mode to the other of the default mode and the history mode, and displaying the at least one document box and files according to the other of the default mode and the history mode.

Displaying the at least one document box and files corresponding to predetermined history parameters may include displaying the at least one document box and files only if the at least one document box and files have been accessed by a user presently logged in to the image forming apparatus in a predetermined period of time.

The predetermined period of time may be one of ever, within the last week, within the last two weeks, within the last month, and within a date range defined by the user presently logged in to the image forming apparatus.

The method may further include, when a user selects a displayed document box in the history mode, displaying only files stored in the document box that correspond to the predetermined history parameters.

Displaying the at least one document box and files corresponding to predetermined history parameters may include displaying the at least one document box and files on a display of a host device connected to the image forming apparatus.

The files stored in the at least one document box may be files that have been the subjects of at least one of a printing operation, a scanning operation, a faxing operation, an email operation, and a data transmission operation.

Features and/or utilities of the present general inventive concept may also be realized by an image forming apparatus, including memory to store at least one document box which stores at least one file, a display unit to display a graphical user interface (GUI) representing the at least one document box and the at least one file, and a controller to cause the display unit to display the GUI according to one of a default mode and a history mode, the default mode displaying the files regardless of access history of a user accessing the files and the history mode displaying the files based on the access history. When the controller causes the display unit to display the GUI according to the history mode, the display unit may display only the document boxes and files of the at least one document box and at least one file that correspond to predetermined history parameters.

The image forming apparatus may further include a user input unit to receive a user input to select one of the default mode and the history mode.

The user input may receive log-in information of a user, and the display may display only the document boxes and files of the at least one document box and at least one file that correspond to the logged-in user.

The image forming apparatus may further include a communication unit to receive an input from a host device external to the image forming apparatus, and wherein the input may include at least one of log-in information of a user and a selection of one of the default mode and the history mode.

When the controller controls the display unit to display the at least one document box and at least one file in the history mode, the control unit may cause the display unit to display only the document boxes and files that a logged-in user has accessed within a predetermined period of time.

The predetermined period of time may be selectable by a user and may include at least one of ever, within the last week, within the last two weeks, within the last month, and within a date range determined by the user.

Features and/or utilities of the present general inventive concept may also be realized by an image forming system, including a host device and an image forming apparatus. The host device may include a display unit to display a graphical user interface (GUI) representing the at least one document box and the at least one file and a communication interface. The an image forming apparatus may include memory to store at least one document box which stores at least one file, a communication unit to transmit data to and receive data from the communication interface of the host device, and a controller to transmit data to the display unit of the host device to cause the display unit to display the GUI according to one of a default mode and a history mode, the default mode displaying the files regardless of access history of a user accessing the files and the history mode displaying the files based on the access history. When the controller transmits data to the display unit to cause the display unit to display the GUI according to the history mode, the display unit may display only the document boxes and files of the at least one document box and at least one file that correspond to predetermined history parameters.

The host device may further include a user input unit to receive a user input to select one of the default mode and the history mode.

The host device may further include a user input unit to receive log-in information of a user, wherein the display displays only the document boxes and files of the at least one document box and at least one file that correspond to the logged-in user.

When the controller transmits data to the host device to control the display unit to display the at least one document box and at least one file in the history mode, the control unit may cause the display unit to display only the document boxes and files that a logged-in user has accessed within a predetermined period of time.

Features and/or utilities of the present general inventive concept may also be realized by a non-transitory computer-readable medium having stored thereon code to execute a method in an image forming apparatus, the method including detecting a set display mode among at least a default mode and a history mode to display files stored in at least one document box of the image forming apparatus, the default mode displaying the files regardless of access history of a user accessing the files and the history mode displaying the files based on the access history, and, when the history mode is detected, displaying the at least one document box and files corresponding to predetermined history parameters.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is a diagram illustrating a configuration of an image forming system according to an embodiment of the present general inventive concept;

FIG. 2 is a selection window to select a document box and a mode displayed on the display unit of the image forming apparatus, according to an embodiment of the present general inventive concept;

FIG. 3A illustrates a window to select a time period to be displayed in the history mode according to an embodiment of the present general inventive concept;

FIG. 3B is a view illustrating a window for inputting time information displayed on the display unit of the image forming apparatus, according to an embodiment of the present general inventive concept;

FIG. 4 is a selection window including a document box, buttons to select a mode, and a slider bar for inputting time information, which are displayed on the display unit of the image forming apparatus, according to an embodiment of the present general inventive concept;

FIG. 5 is a view illustrating switching between a default mode and a history mode, according to an embodiment of the present general inventive concept;

FIG. 6 is a view illustrating data stored in the history management database, according to an embodiment of the present general inventive concept;

FIG. 7 is a view illustrating data stored in the mode management database, according to an embodiment of the present general inventive concept;

FIG. 8 is a flowchart illustrating a method of setting a display mode of the image forming apparatus, according to an embodiment of the present general inventive concept; and

FIG. 9 is a flowchart illustrating a method of determining a setting, displaying files according to the setting, and detecting a changed setting.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

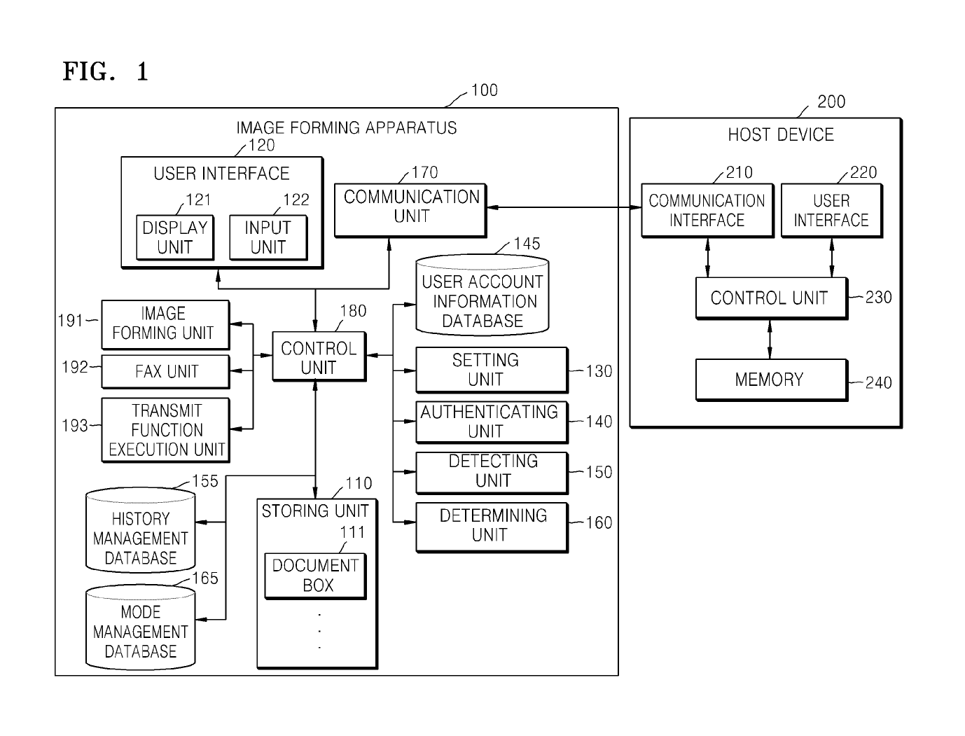

FIG. 1 is a diagram illustrating a configuration of an image forming system according to an embodiment of the present general inventive concept. Referring to FIG. 1, the image forming system includes an image forming apparatus 100 and a host apparatus or device 200. Referring to FIG. 1, the image forming apparatus 100 includes a storing unit 110, a document box 111, a user interface 120, a display unit 121, an input unit 122, a setting unit 130, an authenticating unit 140, a user account information database 145, a detecting unit 150, a history management database 155, a determining unit 160, a mode management database 165, a communication unit 170, a control unit 180, an image forming unit 191, a fax unit 192, and a transmit function execution unit 193. The host 200 includes a communication interface 210, a user interface 220, a control unit 230, and a memory 240.

Only components related to the present embodiment are illustrated in the image forming apparatus 100 and the host apparatus 200 of FIG. 1. Accordingly, it is apparent to those skilled in the art that other general components besides the components of FIG. 1 may be further included in an image forming apparatus and host device.

Although it is illustrated in FIG. 1 that only one host apparatus 200 is connected to the image forming apparatus 100, the present general inventive concept is not limited thereto and a plurality of host apparatuses like the host apparatus 200 may be connected to the image forming apparatus 100. Although it is illustrated in FIG. 1 that only one image forming apparatus 100 is connected to the host apparatus 200, the present general inventive concept is not limited thereto and a plurality of image forming apparatuses like the image forming apparatus 100 may be connected to the host apparatus 200.

The image forming apparatus 100 and the host apparatus 200 respectively use the communication unit 170 and the communication interface 210 to transmit and receive data through wired/wireless networks or wired serial communications. The networks may correspond to the Internet, a local area network (LAN), a wireless LAN, a wide area network (WAN), and a personal area network (PAN), but are not limited thereto. That is, other various kinds of networks capable of transmitting and receiving information may be used. The communication unit 170 may include one or more ports and/or antennas to transmit data to the above networks or data connections. The communication unit 170 may also include one or more data processors, buffers, and other hardware to convert, compress/decompress, or otherwise process data to transmit to and from the control unit 180 and other components of the image forming apparatus 100.

The image forming apparatus 100 may include files for printing, copying, scanning, fax transmitting, e-mail sending, and server file transferring operations and the document box 111 for managing the files. The files and the document box 111 may be stored in the storing unit 110 of the image forming apparatus 100. The storing unit 110 may be a memory device, including a hard disk drive (HDD), a read only memory (ROM) of a high capacity, a random access memory (RAM), a flash memory, a memory card, or any other memory device. The document box 111 may correspond to predetermined addresses of the storage unit 110, such that files stored in the predetermined addresses are stored in the document box 111. The document box 111 may also include a graphical aspect that may be displayed on the display unit 121, so that the document box 111 may include predetermined storage addresses and a display program. The size of the document box 111, or the addresses associated with the document box 111 may be increased or decreased as needed, and the addresses need not be consecutive in the storing unit 110.

The storing unit 110 may store document boxes 111 corresponding to a plurality of users of the image forming apparatus 100 and files in the document boxes 111. The document box 111 may classify the files according to predetermined properties. In other words, the program that defines the document box 111 may include management algorithms to identify and organize files and/or folders according to predetermined properties, such as by time stamps, types of files, types of functions with which the file has been used, etc. The control unit 180 may execute the program that defines the document box 111 to manage or organize the files within the document box 111 accordingly. The files may be generated in the image forming apparatus 100 by using scan data, fax data, and e-mail data and print data, which are used for printing, copying, scanning, fax transmitting, e-mail sending, and server transferring operations.

The scan data is generated according to a result of performing a scan operation in the image forming apparatus 100, the fax data is generated according to a result of performing a fax transmitting and receiving operation in the image forming apparatus 100, and the e-mail data is generated according to a result of performing an e-mail sending and receiving operation in the image forming apparatus 100. In addition, the print data may be received from the host apparatus 200 connected to the image forming apparatus 100.

The document box 111 stores at least one file. That is, the document box 111 is used to systematically manage the files stored in the storing unit 110 and the document box 111 may be a directory or a folder.

The storing unit 110 may store one or more document boxes 111 and may classify the document boxes according to predetermined properties. For example, the document boxes may include a public box, a secure box, and a user box. A public box may be accessed by all users of the image forming apparatus 100, so that any user may create, delete, modify, and view a public box. The secure box may be created, deleted, modified, or viewed only by permitted or authorized users. User boxes may be classified by user, so that each user may create, delete, modify, and view their own box. The document box 111 discussed below may be a user box, for example.

The public box, the secure box, and the user box are just examples of document boxes 111 classified by properties and thus their kinds are not limited thereto. These boxes may comprise computer code stored in memory including predetermined addresses indicating the locations of files of the respective boxes in memory. The code may also include data corresponding to authorized users, or users that are allowed to create, modify, view, or delete the respective boxes.

The user interface 120 obtains input information from a user and displays output information to the user. The user interface 120 includes the display unit 121 to display the output information and the input unit 122 to obtain the input information. However, the user interface 120 may have an integrated form of the display unit 121 and the input unit 122. For example, the user interface 120 of the image forming apparatus 100 may include input/output devices such as a display panel, a mouse, a keyboard, a touch screen, a monitor, and a speaker and a software application to enable the operation of an input/output device. Moreover, the display unit 121 may display various information using a graphical user interface (GUI).

The input unit 122 obtains log-in information from a user. That is, the user manipulates the input unit 122 to input the log-in information. The log-in information may include a user identification (ID) and a user password.

In addition, the input unit 122 obtains input information from a user to set a display mode. That is, the user inputs the input information by manipulating the input unit 122 to select a display mode displayed in the display unit 121.

The setting unit 130 sets a mode to display the document box 111 and files stored in the storing unit 110. The setting unit 130 may set the mode with reference to the input information obtained from the input unit 122 or information received from the host apparatus 200 through the communication unit 170. The display mode means a method of displaying the document box 111 and files stored in the storing unit 110, and the mode, which is displayed based on the display mode corresponding to a user of the image forming apparatus 100, means that the display mode is set with respect to each of a plurality of users.

If a mode (which is displayed according to a display mode corresponding to a user of the image forming apparatus 100) is set, a display mode for each of the users of the image forming apparatus 100 may be configured and the image forming apparatus 100 may display the document box 111 and files stored in the storing unit 110 according to a display mode set by a permitted user among the plurality of users.

The display mode includes a default mode and a history mode based on a usage history of the document box 111 and the files. The usage history may include at least one of the latest period, an access frequency, and a security level of the document box and files, and the usage history may be edited by a user. A history mode will be described in more detail below.

The setting unit 130 may include a program stored in memory, such as the storing unit 110 or other memory, and one or more processors, such as a processor of the control unit 180 to execute the program. The program may receive a user input via the input unit 122 or may retrieve stored setting data from memory, such as the storing unit 110, and may set a display mode of a document box 111 on the display unit 121 according to the retrieved setting data. The setting unit 130 may include dedicated memory, processors, logic units, and other electrical components, or it may include a computer program stored in memory that is executed by processors and logic units of the control unit 180, for example.

The authenticating unit 140 authenticates the log-in information acquired via the user interface 120. That is, the authenticating unit 140 authenticates the log-in information acquired from one of the users of the image forming apparatus 100 via the user interface 120 or the communication unit 170. The authenticating unit 140 authenticates the log-in information acquired through the user interface 120 with reference to the user account information database 145 to store account information of a plurality of users of the image forming apparatus 100. The user account information database 145 stores and manages account information about a plurality of users of the image forming apparatus 100. The account information may include a user ID and a user password, and the managing the account information may include updating the user information automatically or according to user input.

That is, the authenticating unit 140 compares the log-in information acquired from a user with the account information of a user, which is stored in the user account information database 145, to authenticate the user.

If the log-in information is identical to the account information stored in the user account information database 145, the user is authenticated as a permitted user and may access one or more document boxes 111 or functions of the image forming apparatus 100. On the other hand, if the log-in information is not identical to the account information stored in the user account information database 145, the user is denied to access the image forming apparatus 100 or is allowed to perform only certain operations, such as viewing a document box 111, such as a public box, without changing the properties or contents of the document box 111.

The authenticating unit 140 may include software stored in memory, such as in the storing unit 110, for example, and/or processors, logic, and other electrical components to receive data, process the data, and output an authentication result. The authentication unit 140 may include dedicated processors, memory, and logic units, or the authentication unit 140 may include a computer program stored in memory and executed by a processor and logic units of the control unit 180, for example.

According to an authentication result of the authenticating unit 140, the display unit 121 displays the document box 111 and files stored in the storing unit 110 according to a display mode configured in the setting unit 130. That is, if the setting unit 130 sets a mode (which is displayed according to a display mode corresponding to a user of the image forming apparatus 100), the document box 111 and files are displayed according to the display mode set by a user corresponding to the log-in information authenticated by the authenticating unit 140.

For example, if a default mode is set by one of the plurality of users of the image forming apparatus 100, once the user is authenticated by the authenticating unit 140, the display unit 121 displays the document box 111 and files stored in the storing unit 110 according to the default mode.

Or, if a history mode is set by another user of a plurality of users of the image forming apparatus 100, once the user is authenticated by the authenticating unit 140, the display unit 121 displays the document box 111 and files stored in the storing unit 110 according to the history mode.

Accordingly, the authenticated user may select at least one of the document box 111 and file displayed on the display unit 121 by using the input unit 122. The image forming apparatus 100 may perform printing, faxing, scanning, fax transmitting, and e-mail sending operations with respect to the selected document box 111 and files.

Displaying of the document box 111 and files according to the display mode will be described in more detail below. The display unit 121 displays at least one document box 111 corresponding to the authorized log-in information among the plurality of the document boxes 111 and files stored in the storing unit 110. For example, at least one document box 111 corresponding to the authorized log-in information may be a public box or a user box corresponding to the authorized log-in information.

The display mode of the display unit 121 may be changed by the permitted user. That is, the display unit 121 may further display a button to select one of a default mode or a history mode. The button to select one of the default mode or the history mode may be displayed in addition to at least one document box 111 corresponding to the authorized log-in information.

The default mode may display the document box 111 corresponding to a user corresponding to the authorized log-in information and files stored in the document box 111, and the history mode displays the document box 111 and files based on a usage history of a user corresponding to the authorized log-in information.

For example, the default mode may display file folders and files in alphabetical or chronological order, and the history mode may display only the file folders and/or files that a user has accessed either at any time or within a predetermined period of time. In other words, in the history mode, the display unit 121 displays only the document box 111 and files accessed by the user corresponding to the authorized log-in information at any time in the past. Those files and/or folders that the user has not accessed may be omitted from the display in the history mode. Moreover, the display unit 121 may display only the files and document box 111 accessed at least one time within a predetermined period (for example, one month) based on a set period.

Moreover, the display unit 121 may display the document box 111 and files with reference to an access frequency of the document box 111 and files of a user corresponding to the authorized log-in information. That is, the display unit 121 may display only the files and document box 111 accessed more than the predetermined number of times (for example, 10 times) by a user corresponding to the authorized log-in information.

Moreover, the display unit 121 may display the document box 111 and files with reference to a security level of the document box 111 and files of a user corresponding to the authorized log-in information. That is, the display unit 121 may display only the files and document box 111 corresponding to a security level set by a user corresponding to the authorized log-in information. For example, only the security set file and document box 111 may be displayed.

The above-mentioned usage history may be edited by a user corresponding to the authorized log-in information. That is, setting of a period, an access frequency, and a security level may be editable. For example, when only the files and document box 111, which are accessed the predetermined number of times by a user corresponding to the authorized log-in information, are displayed, the predetermined number of times may be editable.

Moreover, a user corresponding to the authorized log-in information may select and set a plurality of usage histories. That is, the display unit 121 may display only the files and document box 111 accessed more than 10 times within a predetermined period (for example, one month) according to a setting.

Hereinafter, for convenience of description, a mode to display all the files and document boxes 111 corresponding to the permitted user is named as a default mode and a mode to display the files and document box 111 based on a usage history of the permitted user is named as a history mode, but it is apparent to those skilled in the art that the default mode and the history mode are naming examples of modes to display the files and document box 111, and other naming for performing the above-described functions may be used.

Moreover, the display unit 121 displays the set display mode when a user corresponding to the log-in information is a permitted user according to an authentication result of the authenticating unit 140. That is, the display unit 121 provides information about a mode, for currently displaying the file and document box 111, which is either default mode or history mode. Here, a user can edit a mode for currently displaying the file and document box 111.

For example, a user may select one document box 111 from among one or more document boxes 111 being displayed on the display unit 121. In addition, one of a default mode and a history mode may be selected. At this point, a user may manipulate the input unit 112 to select the document box 111 and one of the default mode and the history mode. Moreover, a user may select the document box and one of the default mode and the history mode by touching a user interface 120, such as a display panel.

Once the history mode is selected by the user, the detecting unit 150 detects the document box 111 and files according to the set usage history among the files stored in the document box 111 selected by the user and document boxes 111. For example, if the set usage history is the latest used period, the detecting unit 150 detects the files and document boxes 111 accessed at least one time by the user.

The detecting unit 150 may include software stored in memory, such as in the storing unit 110, for example, and/or processors, logic, and other electrical components to receive data corresponding to the stored document boxes 111, process the data, and output data corresponding to parameters set by a user or stored in memory to display data corresponding to the document boxes 111. The detecting unit 150 may include dedicated processors, memory, and logic units, or the detecting unit 150 may include a computer program stored in memory and executed by a processor and logic units of the control unit 180, for example.

In other words, according to user settings in the history mode, the detecting unit 150 may detect files and document boxes 111 that have been accessed at least one time by a user with reference to the history management database 155 to store information about the latest access time that a plurality of users of the image forming apparatus 100 access a plurality of document boxes 111 and files stored in the storing unit 110.

The history management database 155 stores and manages information about the latest time that a plurality of users of the image forming apparatus 100 access each of the plurality of document boxes 111 and files. However, since the document box 111 stores files, the history management database 155 may store and manage information about the latest access time by each user with respect to only document boxes 111 stored in the storing unit 110.

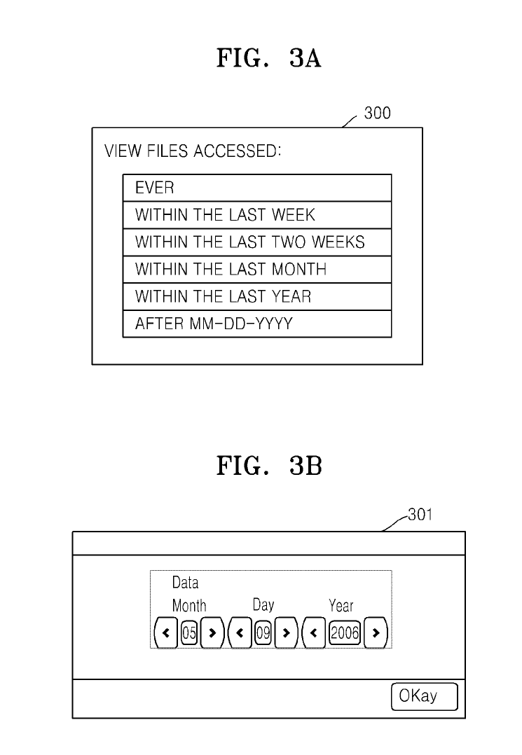

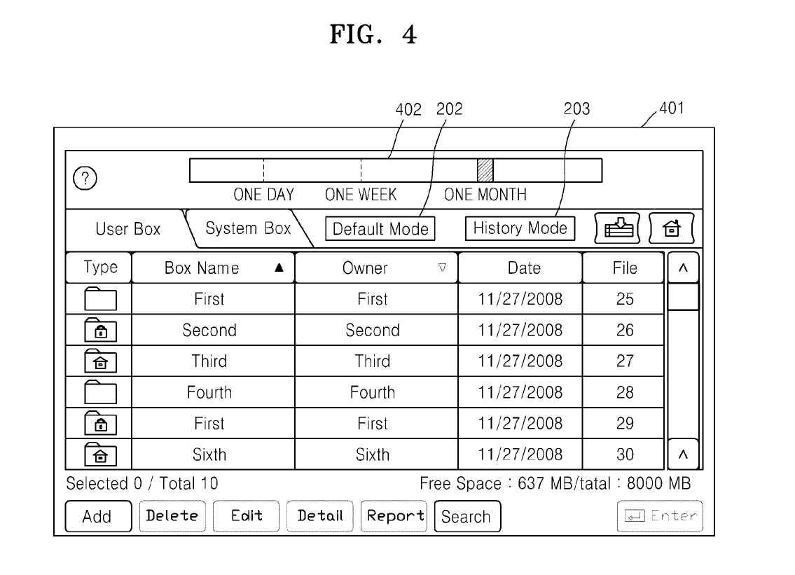

In addition, the input unit 122 may receive time information from a user to set a predetermined period to include in the detection parameters of the detecting unit 150. For example, as illustrated in FIG. 3A, the display unit 121 may display to a user various predetermined time periods and the user may select a particular predetermined time period to include in the detection parameters of the detecting unit. The predetermined period may be one day, one week, or one month, etc. In addition, as illustrated in FIGS. 3B and 4, respectively, the display unit 121 may further display a pop-up window to acquire time information from a user or a slide bar for acquiring time information in addition to the document box 111 corresponding to a user corresponding to the authenticated log-in information.

The detecting unit 150 may detect the files and document box 111 accessed at least one time by the user within a predetermined period of the acquired time information with reference to the history management database 155. For example, if a user sets the predetermined period as one week, the detecting unit 150 detects only the files and document boxes 111 accessed at least one time by the user from the current moment to one week before.

The display unit 122 displays the files and document boxes 111 detected by the detecting unit 150. That is, once the history mode is selected by a user, the display unit 122 displays the document box 111 and files accessed at least one time by the user among a plurality of files stored in the document box 111 selected by the user and document boxes 111. In addition, once the history mode is selected by the user and the time information to set a predetermined period is inputted, the display unit 122 displays the document box 111 and files accessed at least one time within the predetermined period set by the user among a plurality of files stored in the document box 111 selected by the user and document boxes 111.

Accordingly, a user may conveniently set a display mode of the image forming apparatus 100, and thus may conveniently search for only the file and document box 111 having a history accessed by the user among a plurality of document boxes 111 stored in the storing unit 110 and a plurality of files stored in the document box 111.

As a storage capacity of the storing unit 110 in the image forming apparatus 100 is increased, a great number of document boxes 111 and files can be stored in the storing unit 110. Accordingly, in order to search for document boxes 111 and files that the user wants, conventionally all the document boxes 111 stored in the storing unit 110 must be reviewed or a searching function needs to be performed. However, the reviewing or searching of all the document boxes 111 may take long time because all the document boxes 111 and files stored in the storing unit 110 need to be searched.

Accordingly, since files for performing printing, fax transmitting, file transferring functions have a history that is accessed at least one time by a user, the user can conveniently search the document boxes 111 and files through the history mode to display the files and document boxes 111 having an access history in the image forming apparatus 100. Moreover, by acquiring the time information to set a predetermined period from a user, the accuracy of a searching result may be further improved because the document box 111 and files that have not been used for a long period are excluded.

Moreover, the user interface 120 may display the document box 111, a button to select the default mode or the history mode, and a button for the inputting time information in one window to thus improve user convenience.

A user can select the default mode when the files and document box 111 detected according to the history mode are displayed or can select the history mode when the files and document box 111 detected according to the default mode are displayed, through the input unit 121. That is, the selection is possible between the history mode and the default mode. For example, the history mode and the default mode may be changeable.

Accordingly, the detecting unit 150 detects the document boxes 111 and files stored in the document box 111 based on the user selection result and the display unit 122 displays the detected files and document boxes 111.

For example, the input unit 122 may obtain the selection information of the history mode when the files and document box 111 detected according to the default mode are displayed on the display unit 121, and the detecting unit 150 may detect the files and document box 111 having a user's usage history when the files and document box 111 detected according to the default mode are displayed among a plurality of files stored in the document box 111 and document boxes 111.

Accordingly, a user can select the default mode or the history mode such that various operations are conveniently performed in the image forming apparatus 100

The determining unit 160 determines the latest mode that a user corresponding to the authorized log-in information has used. The detecting unit 150 detects the files stored in the document box 111 and document boxes 111 according to the mode determined by the determining unit 160. The user interface 120 displays the files and document boxes 111 detected by the detecting unit 150.

The determining unit 160 determines the latest mode that a user corresponding to the authorized log-in information has used with reference to the mode management database 165 storing the latest mode that a user has used.

The mode management database 165 stores and manages information about the latest used mode with respect to each of a plurality of users. For example, the mode management database 165 stores and manages information about whether the latest used mode is the default mode or the history mode according to each user.

Accordingly, even when a user does not select one of the default mode and the history mode, the document box 111 and files are displayed according to the latest mode that a user has used to thus improve user convenience.

The communication unit 170 transmits and receives data to and from an external device via a network. The communication unit 170 may include a modem used for fax transmitting, a network module for connection with a network, and a universal serial bus (USB) host module for forming a data transfer channel with a mobile storing unit medium, according to functions of the image forming apparatus 100.

The image forming apparatus 100 may perform a method of setting a display mode of the image forming apparatus 100, as described above, on the host apparatus 200 connected to the image forming apparatus 100. That is, through the communication unit 170 and the communication interface 210 in the image forming apparatus 100 and the host apparatus 200, respectively, a user can set the display mode of the image forming apparatus 100 and accordingly, can search the files and document boxes 111 stored in the image forming apparatus 110.

For example, the communication unit 170 may be connected to the host apparatus 200 via a network. A user may log in to the image forming apparatus 100 at the host apparatus 200. That is, the image forming apparatus 100 receives log-in information from the host apparatus 200 through the communication unit 170.

The receiving of the login information is generally performed by inputting a user ID and a user password of a user of the host apparatus 200 when the host apparatus 200 is connected to the image forming apparatus 100, or also may be performed by automatically providing log-in information from the host apparatus 200 to the image forming apparatus 100 when the image forming apparatus 100 is connected to the host apparatus 200. That is, it is apparent that the image forming apparatus 100 can receive the log-in information without a log-in process according to predetermined settings.

In addition, the authenticating unit 140 may authenticate the received log-in information. The control unit 180 may control the display unit 121 or the user interface 220 to display the document box 111 and files stored in the image forming apparatus 100 according to the display mode set to display the document box 111 and files corresponding to the log-in information of the connected external apparatus. Accordingly, the communication unit 170 transmits the information about the document box 111 and files to the host apparatus 200 according to the display mode corresponding to the authenticated log-in information. Accordingly, the document box 111 and files transmitted from the image forming apparatus 100 may be displayed on the user interface 220 of the host apparatus 200.

The communication unit 170 receives information to select the default mode or the history mode from a user of the host apparatus 200, and the detecting unit 150 detects the files stored in the document box 111 and document box 111 according to the received mode. The communication unit 170 transmits information about the detected files and document box 111 to the host apparatus 200. Accordingly, the display mode to display the document box 111 and files may be changed by the host apparatus 200.

In addition, the communication unit 170 receives time information to set a predetermined period from the host apparatus 200, and the detecting unit 150 detects the files and document box 111 accessed at least one time by the host apparatus 200 within a predetermined period of the time information with reference to the history management database 155. Then, the communication unit 170 transmits information about the detected files and document box 111 to the host apparatus 200.

Moreover, the detecting unit 150 detects the files and document box 111 according to the latest mode that a user of the host apparatus 200 has used based on the determination result of the determining unit 160. The communication unit 170 transmits information about the detected files and document box 111 to the host apparatus 200.

Accordingly, a user can search the files and document box 111 stored in the image forming apparatus 100 conveniently and remotely by using the host apparatus 200.

The control unit 180 controls general operations of the image forming apparatus 100. In addition, the control unit 180 controls the components of the image forming apparatus 100 to display the document box 111 and the files stored in the storing unit 110 according to the display mode set in the image forming apparatus 100.

The image forming unit 191, the fax unit 192, and the transmit function execution unit 193 may perform various functions of the image forming apparatus 100. The image forming unit 191 performs a printing operation of a file, the fax unit 192 performs a fax transmitting operation of a file, the transmit function execution unit 193 performs a transmitting operation to transmit files to external apparatuses such as a server, a mobile storage medium, and a computer system.

Accordingly, a user of the image forming apparatus 100 views only the document box 111 and files using a history mode accessed by the user himself or herself, such that the document box 111 and files can be searched conveniently regardless of a complex structure of the document box 111. Moreover, accessibility about previously used information can be improved by mode switching between the default mode and the history mode, and also user convenience can be enhanced by simultaneously performing an operation for adding information about a newly accessed history to the database.

The host apparatus 200 may include at least one of a general computer system to control the image forming apparatus 100 when connected to the image forming apparatus 100 and an image forming apparatus different from the image forming apparatus 100. For example, the host apparatus 200 may include a general computer system, a mobile system, a personal digital assistant (PDA), and an image forming apparatus in order to remotely manage files stored in the image forming apparatus 100, when connected to the image forming apparatus 100.

The communication interface 210 transmits or receives data to or from the image forming apparatus 100. That is, the communication interface 210 transmits or receives to or from the image forming apparatus 100, log-in information, authentication information, selection information to select one a history mode and default mode, and information about the detected file and document box 111.

The user interface 210 obtains input information from a user and displays output information to a user. The user interface 210 may display information received from the image forming apparatus 100 using a web user interface.

The control unit 230 controls general functions of the host apparatus 200 and the memory 240 stores a program that controls the host apparatus 200. Moreover, the memory 240 may further include a program memory (not shown) and a data memory (not shown). The program memory stores a program to control general operations of the host apparatus 200. The data memory temporarily stores data generated during the executing of the programs.

Accordingly, a user may set the display mode of the image forming apparatus 100 by using the host apparatus 200 such that the files and document box 111 stored in the image forming apparatus 100 can be searched remotely and conveniently, and functions such as the printing, fax transmitting, e-mail sending, and file transferring to a server can be performed using the detected files and document box 111.

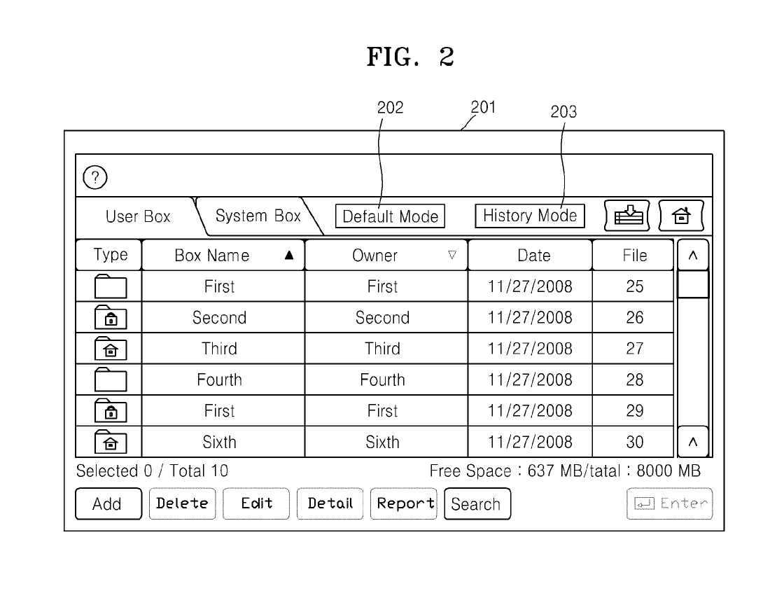

FIG. 2 is a selection window 201 to select a document box 111 and a mode displayed on the display unit 121 of the image forming apparatus 100, according to an embodiment of the present general inventive concept. Referring to FIG. 2, the selection window 201 includes at least one document box 111 corresponding to a permitted user, a button 202 to select a default mode, and a button 203 to select a history mode.

A user selects one of the document boxes 111 displayed on the selection window 201 and one of the button 202 to select the default mode and the button 203 to select the history mode. If the button 202 to select a default mode is selected, the document box 111 and files corresponding to the permitted user are displayed according to the default mode. If the button 203 to select a history mode is selected, only the document box 111 and files accessed at least one time by a user among document boxes 111 and files corresponding to the permitted user are displayed according to the history mode. The selection may be performed by touching the document box 111 or the buttons 202 and 203.

FIG. 3A illustrates a window 300 including a plurality of time options selectable by a user when the user selects a history mode to view one or more document boxes 111 and files. The user may view any documents ever viewed, created, or modified by the user, or documents accesses within the last week, two weeks, month, year, etc. The window 300 may be displayed on the display unit 121 of the image forming apparatus 100 or on the user interface 220 of the host apparatus 200, respectively. In the history mode, files and/or folders that have never been accessed by the user may be omitted from the display. In addition, when a predetermined period of time is selected, than any files and/or folders that were not accessed by the user within the predetermined period of time may be omitted from the display.

FIG. 3B is a view illustrating a window 301 for inputting time information displayed on the display unit 121 of the image forming apparatus 100 or the user interface 220 of the host apparatus. Referring to FIG. 3, the window 301 is used by a user to input time information by a user and may be displayed as a pop-up window. That is, a user may adjust a date of the window 301 to input the time information to set a predetermined period, and views only the document box 111 and files from the adjusted date.

Accordingly, a user may set a predetermined period and may view only the document box 111 and files having a history accessed within the predetermined period.

FIG. 4 is a selection window 401 including a document box 111, buttons 202 and 203 to select a mode, and a slider bar 402 for inputting time information, which are displayed on the display unit 121 of the image forming apparatus 100. Referring to FIG. 4, the slider bar 402 may be displayed on the selection window 401 to input time information. A user can set a predetermined period by touching the slider bar 402 and also can view the document box 111 and files having a history accessed within the predetermined period set by the user.

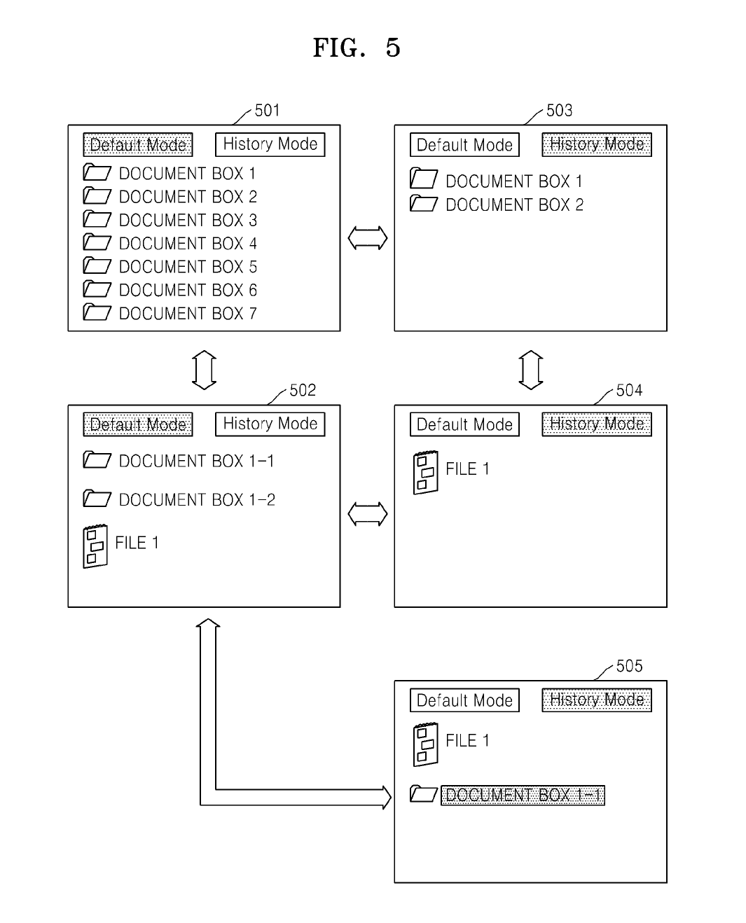

FIG. 5 is a view illustrating switching between a default mode and a history mode. Referring to FIG. 5, a window 501 may be displayed when the default mode is selected. For example, the window 501 may be displayed when document boxes 1 to 7 are stored in the image forming apparatus 100 corresponding to a user.

If the document box 1 is selected from the window 501, since the currently selected mode is the default mode, a window 502 including all the document boxes and files stored in the document box 1 is displayed. That is, the document box 1 stores a document box 1-1, a document box 1-2, and a file 1.

On the other hand, when the set usage history is a period and a history mode is selected from the window 501, only the document box having a history accessed at least one time by the user is displayed. For example, if the document boxes 1 and 2 have been accessed at least one time by the user, a window 503 is displayed.

If the history mode is selected in the window 502, only the document box and files having a history accessed at least one time by the user are displayed. For example, if the file 1 has been accessed at least one time by the user, a window 504 is displayed.

Moreover, if the document box 1 is selected in the window 503, since the selected current mode is the history mode, the window 504 including the document box and files with a history accessed at least one time by the user among the document boxes and files stored in the document box 1 is displayed.

When an operation is performed on the document box 1-1 in the window 502 and the history mode is selected, a window 505 is displayed. That is, the document box 1-1 having a new access history by a user may be displayed in the history mode.

Accordingly, a user may perform various operations conveniently in the image forming apparatus 100 by switching between the history mode and the default mode.

The windows 201, 301, 401, and 501 to 505 shown in FIGS. 2 through 5 may be displayed on the display unit 121 of the image forming apparatus 100 through a graphical user interface (GUI), or may be displayed through the user interface 210 of the host apparatus 200 using a web user interface.

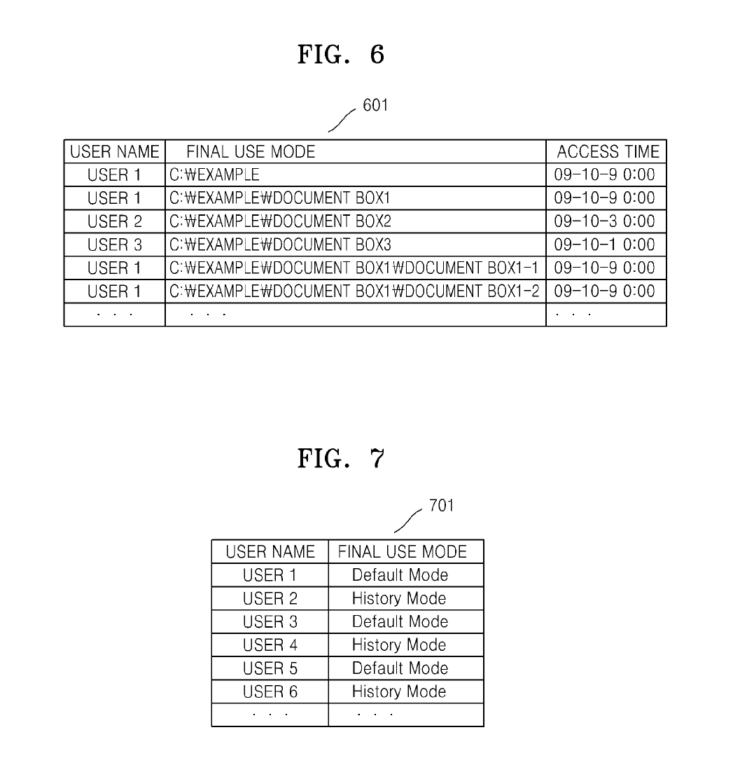

FIG. 6 is a view illustrating data stored in the history management database 155. Referring to FIG. 6, a table 601 stores the latest access time that a plurality of users of the image forming apparatus 100 access the document box 111 and files stored in the image forming apparatus 100.

Accordingly, the detecting unit 150 may detect the files and document box 111 having a history accessed at least one time by the user within a predetermined period set by the user with reference to the history management database 155.

FIG. 7 is a view illustrating data stored in the mode management database 165. A table 701 stores the latest mode that a plurality of users of the image forming apparatus 100 have used.

Accordingly, the determining unit 160 determines the latest mode that a user has used with reference to the mode management database 165.

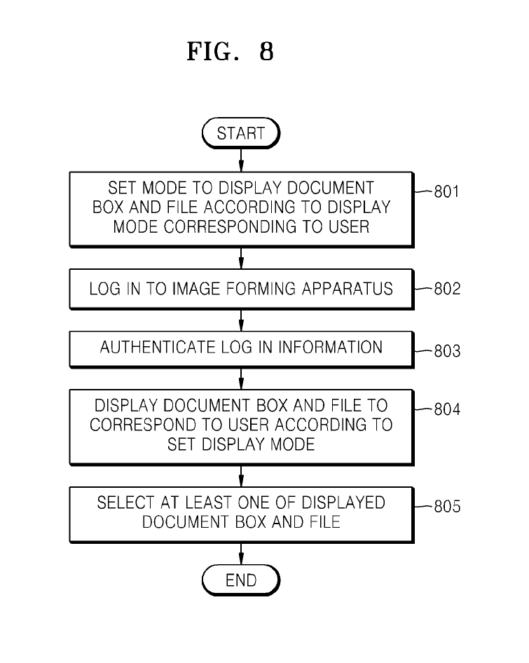

FIG. 8 is a flowchart illustrating a method of setting a display mode of the image forming apparatus 100, according to an embodiment of the present general inventive concept. Referring to FIG. 8, the method of FIG. 8 includes operations that are processed according to time in the image forming system of FIG. 1. Accordingly, even if there are some omitted elements, the above-described elements related to the image forming system of FIG. 1 may be applied to the method of FIG. 8.

In operation 801, the setting unit 130 sets a mode to display the document box 111 and files stored in the image forming apparatus 100 according to a display mode corresponding to a user of the image forming apparatus 100.

In operation 802, a user logs in to the image forming apparatus 100. That is, the input unit 122 or the communication unit 170 obtains the log-in information from a user. The log-in information may include a user ID and a user password.

In operation 803, the authenticating unit 140 authenticates the log-in information according to the log-in process. That is, the authenticating unit 140 authenticates the log-in information of a user with reference to the user account database 145.

In operation 804, the display unit 121 displays the document box 111 and files stored in the image forming apparatus 100 being corresponding to a user that corresponds to the authenticated log-in information, according to the display mode set in operation 801. That is, the display unit 121 displays only the files and document box 111 according to the display mode set with respect to a user corresponding to the authorized log-in information.

In operation 805, the input unit 122 receives at least one selected from the document box 111 and files displayed on the display unit 121. That is, a user selects at least one selected from the document box 111 and files displayed on the display unit 121, by manipulating the input unit 122. Accordingly, by using the selected document box 111 and files, various functions supported by the image forming apparatus 100 can be performed.

Accordingly, a user can conveniently set a display mode of the image forming apparatus 100 and also conveniently search the files and document box 111 stored in the image forming apparatus 100. That is, since only the files and document boxes 111 having a history accessed by a user himself or herself are searched, more accurate and preferred files can be searched and various operations using the found files can be performed also.

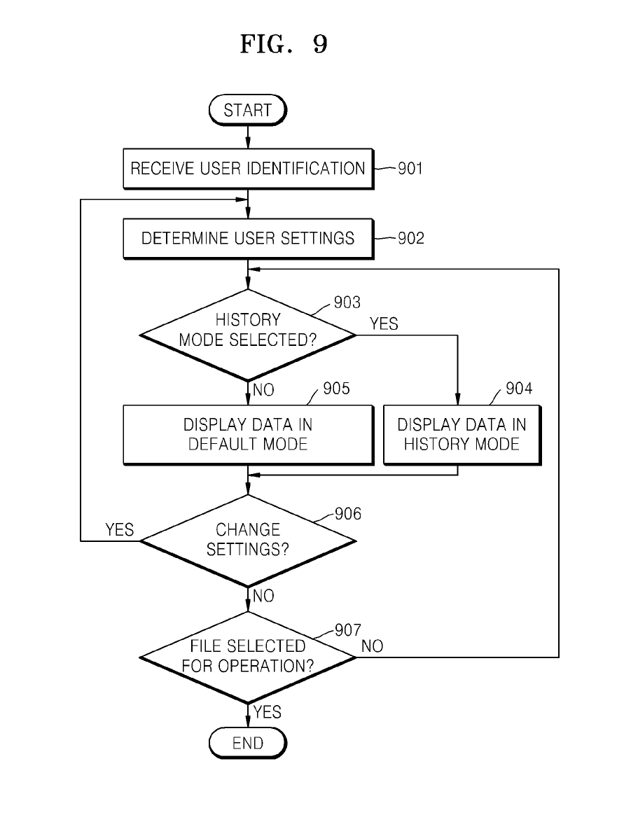

FIG. 9 illustrates a method of determining settings and displaying stored data according to an embodiment of the present general inventive concept. The image forming apparatus 100 may receive a user identification in operation 901 via the input unit 122 or from the communication unit 170 (from the host device 200, for example). The setting unit 130 of the image forming apparatus 100 may determine in operation 902 the settings associated with the user by receiving data from the mode management database 165, from the input unit 122, or from the user interface 220 of the host device 200. In operation 903, if it is determined that the user setting corresponds to the history mode, the control unit 180 may cause the display unit 121 of the image forming apparatus 100 to display one or more document boxes 111 and files stored in the document boxes according to the settings of the history mode. For example, the control unit 180 may receive an input from the detecting unit 150 to cause the display unit 121 to display only files that the user has accessed within the last year.

Similarly, the control unit 180 may output to the communication unit 170 data corresponding to the input received from the detecting unit 150 to be displayed on the user interface 220 of the host device 200. A user may then manipulate the input unit 122 or the user interface 220, respectively, to view or perform an imaging, faxing, or transmitting operation on a file displayed on the respective display devices 122 and 220. For example, a user may select a document box 111, and the display unit 121 may display the files in the document box 111 that the user has accessed within the last year. The user may then select one or more of the files for viewing or performing an imaging or transmission operation.

If it is determined in operation 902 that the user settings correspond to the default mode, then the control unit 180 may cause the display unit 121 or the user interface 220 to display each document box 111 and/or file to which the user has access in operation 905. The user may then search the document boxes 111 and/or files to select one or more files to view, print, fax, or transmit.

After displaying the data corresponding to the history mode or the default mode, the control unit 180 may determine in operation 906 whether a user has indicated that the settings should be changed to the other of the history and the default mode. If the user so indicates, then the selected mode may be saved in the mode management database 165 to correspond to the user, and the setting unit may indicate to the control unit 180 that the control unit should cause the display unit 121 or the user interface 220 to display the corresponding mode.

Once a user has selected one of the history and the default modes, the display of the document box 111 and the corresponding files may remain in the selected mode as the user searches through various files, folders, architecture diagrams, or other displays displayed on the display unit 121 or the user interface 220. Thus, a user may conduct a search while viewing only files and documents that the user has previously accessed ever or within a predetermined period of time, if desired. If the controller 180 determines in operation 907 that a file has been selected for an operation on the image forming apparatus 100, then the search and display process may end.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As discussed above, a display mode of the document box and files stored in the image forming apparatus can be conveniently set. A user can also perform a searching operation of the file and document boxes fast and accurately by selecting one of a history mode (that views for only the files and document boxes having a history accessed by a user himself or herself) and a default mode (that views for all the files and document boxes).

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. A method of setting a display mode of a document box and file, wherein the method is performed in an image forming apparatus comprising at least one document box, a file stored in the at least one document box, and a display unit and connected to an external apparatus via a network, the method comprising:
setting a mode to display the document box and file on the display unit according to the display mode corresponding to a user of the image forming apparatus;
logging in to the image forming apparatus;
authenticating log-in information according to the logging in at the image forming apparatus;
displaying the document box and file stored in the image forming apparatus on the display unit according to the set display mode in accordance with a user corresponding to the authenticated log-in information; and
selecting one of the displayed document box and file,
wherein the display mode includes a default mode and a history mode based on a usage history of the document box and file of the user.

2. The method of claim 1, wherein the usage history comprises at least one of a latest period that the user has used the document box and file, an access frequency, and a security level.

3. The method of claim 2, wherein the usage history is editable by the user.

4. The method of claim 1, further comprising displaying the set display mode according to the authentication result when a user corresponding to the log-in information is an authenticated user,
wherein the display mode is changeable by the user corresponding to the log-in information.

5. The method of claim 1, further comprising:
connecting to the external apparatus via the network; and
displaying the document box and file stored in the image forming apparatus on a user interface of the external apparatus according to the set display mode, based on the log-in information of the external apparatus, when the display mode is set to be displayed corresponding to the log-in information of the connected external apparatus.

6. An image forming apparatus connected to an external apparatus via a network, comprising:
a storing unit to store at least one document box and a file stored in the at least one document box;
a setting unit to set a mode to display the stored document box and file according to a display mode corresponding to a user of the image forming apparatus;
an authenticating unit to authenticate log-in information obtained from one of a plurality of users of the image forming apparatus;
a display unit to display the document box and file stored in the storing unit according to the set display mode in accordance with a user corresponding to the authenticated log-in information;
an input unit to obtain input information about selecting one of the displayed document box and file; and
a control unit to control the display of the document box and file stored in the storing unit according to the set display mode,
wherein the display mode includes a default mode and a history mode based on a usage history of the document box and file of the user.

7. The image forming apparatus of claim 6, wherein the usage history comprises at least one of a latest period that the user has used the document and file, an access frequency, and a security level.

8. The image forming apparatus of claim 7, wherein the usage history is editable by the user.

9. The image forming apparatus of claim 6, wherein the display unit further displays the set display mode according to the authentication result when a user corresponding to the log-in information is an authenticated user,
wherein the display mode is changeable by the user corresponding to the log-in information.

10. The image forming apparatus of claim 6, further comprising a communication unit to connect to the external apparatus via the network,
wherein the control unit controls the communication unit to output data to the external apparatus to display the document box and file stored in the image forming apparatus on a user interface of the external apparatus according to the set display mode based on the log-in information of the external apparatus when the display mode is set to be displayed corresponding to the log-in information of the connected external apparatus.

11. The image forming apparatus of claim 6, further comprising a history management database to store information about the latest access time that each of a plurality of users of the image forming apparatus has accessed the document box and file stored in the storing unit.

12. The image forming apparatus of claim 11, further comprising a detecting unit to detect document boxes and files accessed at least one time by a user corresponding to the authenticated log-in information among the document boxes and files stored in the storing unit, with reference to the history management database when the set display mode is the history mode,
wherein the display unit displays the detected document box and file.

13. The image forming apparatus of claim 12, wherein:
the input unit receives time information to set a predetermined period from a user corresponding to the authenticated log-in information;
the detecting unit detects a document box and a file accessed at least one time within a predetermined period of the inputted time information by a user corresponding to the log-in information among the plurality of boxes and files stored in the storing unit; and
the display unit displays the detected document box and file

14. The image forming apparatus of claim 6, further comprising a mode management database to store the latest mode that each of a plurality of users of the image forming apparatus has used.

15. The image forming apparatus of claim 14, further comprising a determining unit to determine the latest display mode that a user corresponding to the authenticated log-in information has used with reference to the mode management database,
wherein the display unit displays the document box and file stored in the storing unit according to the determined display mode.

16. An image forming system comprising an image forming apparatus and a host apparatus connected to the image forming apparatus via a network, comprising:
the image forming apparatus to set a display mode to display a document box and a file stored in the image forming apparatus corresponding to log-in information of the host apparatus, to obtain the log-in information from the host apparatus, to authenticate the obtained log-in information, and to transmit information about the document box and the file to the host apparatus to display the document box and file on the host apparatus according to the set display mode; and
the host apparatus to receive the information about the document box and the file from the image forming apparatus and to display a document box and a file corresponding to the received information.

17. The image forming system of claim 16, wherein a usage history comprises at least one of a latest period that the user has accessed the document and file, an access frequency, and a security level.

18. A method of displaying files stored in an image forming apparatus, the method comprising:
detecting a set display mode among at least a default mode and a history mode to display files stored in at least one document box of the image forming apparatus, the default mode displaying the files regardless of access history of a user accessing the files and the history mode displaying the files based on the access history; and
when the history mode is detected, displaying the at least one document box and files corresponding to predetermined history parameters.

19. An image forming apparatus, comprising:
memory to store at least one document box which stores at least one file;
a display unit to display a graphical user interface (GUI) representing the at least one document box and the at least one file; and
a controller to cause the display unit to display the GUI according to one of a default mode and a history mode, the default mode displaying the files regardless of access history of a user accessing the files and the history mode displaying the files based on the access history,
wherein, when the controller causes the display unit to display the GUI according to the history mode, the display unit displays only the document boxes and files of the at least one document box and at least one file that correspond to predetermined history parameters.

20. An image forming system, comprising:
a host device, comprising:
a display unit to display a graphical user interface (GUI) representing the at least one document box and the at least one file; and
a communication interface; and
an image forming apparatus, comprising:
memory to store at least one document box which stores at least one file;
a communication unit to transmit data to and receive data from the communication interface of the host device; and
a controller to transmit data to the display unit of the host device to cause the display unit to display the GUI according to one of a default mode and a history mode, the default mode displaying the files regardless of access history of a user accessing the files and the history mode displaying the files based on the access history,
wherein, when the controller transmits data to the display unit to cause the display unit to display the GUI according to the history mode, the display unit displays only the document boxes and files of the at least one document box and at least one file that correspond to predetermined history parameters.
